(19) United States
(12) Patent Application Publication
(10) Pub. No.: US 2026/0322294 A1
(43) Pub. Date: Oct. 15, 2026

(54) Compressor of a kit for inflation and/or repair of a tyre

(71) Applicant: Maurizio MARINI, Lugano (CH)

(72) Inventors: Maurizio MARINI, Lugano (CH); Alessandro BUZZONI, Lugano (CH)

(73) Assignee: Maurizio MARINI, Lugano (CH)

(21) Appl. No.: 19/565,791

(22) Filed: Mar. 13, 2026

Related U.S. Application Data
(60) Provisional application No. 63/777,774, filed on Mar. 26, 2025.
(60) Provisional application No. 63/829,840, filed on Jun. 25, 2025.

(30) Foreign Application Priority Data
Mar. 13, 2025 (IT) 102025000005202
Jun. 18, 2025 (IT) 102025000014518

(51) Int. Cl. H02P 7/00; B60S 5/04

(52) U.S. Cl. CPC H02P 7/00; B60S 5/04

(57) ABSTRACT

A compressor for inflating a tire includes a direct-current electric motor, a pump driven by the electric motor, a USB outlet or plug, preferably USB-C, for electrical power supply of the electric motor, and an electrical resistance variable over time arranged in series between the electric motor and the USB plug or outlet so as to decrease the resistance during operation of the electric motor and avoid absorbed current peaks while keeping the absorbed current below a predefined threshold.

### CROSS REFERENCE TO THE RELATED APPLICATIONS

This application is based upon and claims priority to Italian Patent Application No. 102025000005202, filed on Mar. 13, 2025; U.S. Provisional Application No. 63/777,774, filed on Mar. 26, 2025; Italian Patent Application No. 102025000014518, filed on Jun. 18, 2025; and U.S. Provisional Application No. 63/829,840, filed on Jun. 25, 2025; the entire contents of which are incorporated herein by reference.

### TECHNICAL FIELD

The invention relates to a compressor for inflating and preferably also repairing a tire of a vehicle.

### BACKGROUND

Tire inflation and repair kits are known in the prior art and are commonly used when a vehicle tire is damaged by a puncture caused, for example, by sharp objects encountered during driving. In addition to the option of using a spare wheel, puncture assistance kits are housed in a vehicle for weight-saving purposes, being usable in the event of damage to the vehicle tires in replacement of a spare wheel. Such puncture assistance kits generally include a compressor for generating compressed air and a sealant that is introduced into the punctured tire of the vehicle. The sealant required for such kits can be applied manually by the user and in this case the compressor performs the single function of inflating the tire, or with the aid of the compressor and in this case the compressor performs two functions, i.e. the injection of the liquid sealant and the subsequent inflation of the tire.

In particular, a kit configuration is known in which a container of liquid sealant is connected to the tire and the sealant is injected manually. After disconnecting the sealant container, the compressor is connected to the tire to be repaired in order to reach the pressure suitable for vehicle driving.

Since such compressor requires an electrical power supply, current kits must be connected to the onboard power outlet of the vehicle via a cable having a plug compatible with the cigarette-lighter power outlet. The latter is progressively replaced by USB, in particular USB-C. Furthermore, the electric power supplied with such new power outlet, i.e. 100 W supplied at 20 V and 5 A. While such power levels may increase in the future, this configuration currently represents a widespread standard. Such power is not capable of satisfying at least one of the conditions of maximum current absorption of a tire compressor, i.e. at the beginning of the injection of the liquid sealant and when it is necessary to reach the operating pressure of the tire, e.g. depending on vehicle models 2.4 bar. In particular, under some operating conditions of the compressor, the current reaches a peak of 33 A absorbed for a few milliseconds: such peak is detected by the vehicle controls and the electric power supply of the USB-C outlet is suspended.

This prevents the switching on of the compressor, i.e. the electric motor does not rotate even though the user, e.g. via an on switch, intends to generate compressed air.

It should furthermore be noted that USB-C is a standard that provides for a negotiation between the vehicle power outlet or power delivery: when the USB-C plug is inserted into the PD, there is an agreement on the constant voltage supplied by the PD and the current is supplied to the user device by the PD based on the load up to a maximum value. In the case of the 100 W PD, the maximum voltage on which there is an agreement between the device to be powered and the PD is 20 V and the nominal current deliverable based on the load is 5 A, as indicated above.

### SUMMARY

The object of the present invention is to provide a compressor for inflating a tire and preferably also for repairing it that overcomes the above-described drawbacks.

The object of the present invention is achieved by means of a compressor according to claim 1.

It has been verified that controlling the rotational speed from a low initial value, i.e. low supply voltage of the electric motor, to a high value, i.e. high supply voltage, allows limiting the average current absorption and, therefore, injecting the liquid sealant and subsequently inflating the tire while complying with the safety logics of the vehicle power delivery.

In particular, through the invention a “soft start” compatible with the vehicle electrical power source is achieved since a supply voltage of the electric motor is increased progressively from a low initial value to a higher final value when the user switches on the electric motor to generate compressed air. The pump starts operating when the user actuates the electric motor, e.g. through an on switch, and progressively reaches the absorbed power up to reaching the maximum power delivered by a power delivery module of an auxiliary electrical circuit of a wheeled motor vehicle, e.g. car, motorcycle, quad e.g. ATV-UTV, small tractor. Furthermore, the capacitor—which may be a single unit or multiple units and charges rapidly, e.g. in less than 2 seconds—enables the supply of the peak current normally required when the electric motor, after being switched on, is powered via the voltage variation device and the pump is under load, e.g. to open a container of sealant using compressed air or to inflate a slightly deflated tyre to the correct pressure. In particular, the voltage regulation device reduces the peak current required during start-up under load.

According to an embodiment variant, the capacitor(s) supply the excess peak current with respect to the maximum current delivered by the power delivery module of the auxiliary electrical circuit of the vehicle. Preferably, the capacitor is arranged immediately downstream of the outlet or plug of the compressor so as to be immediately charged as soon as the compressor is electrically connected to the power delivery module, in particular also with the electric motor switched off. With reference to the figure, the capacitor(s) are sized to supply the reduced peak current, i.e. the peak obtained thanks to the use of the voltage variation device, such current exceeds the maximum rated current supplied by the circuit and such current having to be delivered for the entire time in which the motor requires a power greater than the nominal power of the power delivery module.

Furthermore, the capacitors act as a filter for the electrical noise generated by direct current electric motors, in particular brushed electric motors. In this manner, the highly sensitive safety logics of the power delivery are not activated, allowing a smooth delivery of electrical power.

Preferably, a variable resistor is used, e.g. a Negative Temperature Coefficient (NTC) resistor, which is high when cold, i.e. at start-up, limiting the current peak to about 11 A, and such value allows starting the electric motor, albeit with lower torque. In fact, such value is tolerated by the controls of the onboard USB-C outlet of the vehicle. With increasing temperature due to the Joule effect, the NTC variable resistance decreases until becoming negligible and, at the same time, also the torque values required for operation both during injection of the sealant and for reaching the operating pressure of the tire, e.g. 2.4, are tolerated by the 100 W, 20 V and 5 A circuit. Through appropriate sizing, the compressor of the invention can be sized to operate not beyond 24 V nominal or another voltage, preferably but not exclusively constant, supplied by the power delivery.

Through the invention it is possible to obtain the “soft start” either through a predefined law over time of the increase of the supply voltage based for example on empirical measurements of the compressor in numerous operating conditions, or in an active manner, e.g. by providing a microcontroller programmed to modify the operating parameters of the voltage variation device based on the current, preferably the instantaneous current, absorbed by the electric motor during air delivery. Such variation of the supply voltage of the electric motor is carried out while the voltage received from the power delivery remains constant, preferably constant during the entire working cycle of the compressor.

### BRIEF DESCRIPTION OF THE DRAWINGS

The present invention will now be described in greater detail with reference to the following figures, which show an exemplary and non-limiting embodiment of the invention, in which:

FIG. 1A illustrates an electrical diagram of a compressor for inflating and preferably also repairing a tire according to the present invention;

FIG. 1B illustrates a simplified variant of FIG. 1A;

FIG. 2 qualitatively illustrates the decrease of the current required by the electric motor at start-up when a device for varying the supply voltage is used; and

FIG. 3 is an exemplary view of a kit for repairing and inflating a tire, including a compressor according to the electrical diagram of FIG. 1A or 1B.

### DETAILED DESCRIPTION OF THE EMBODIMENTS

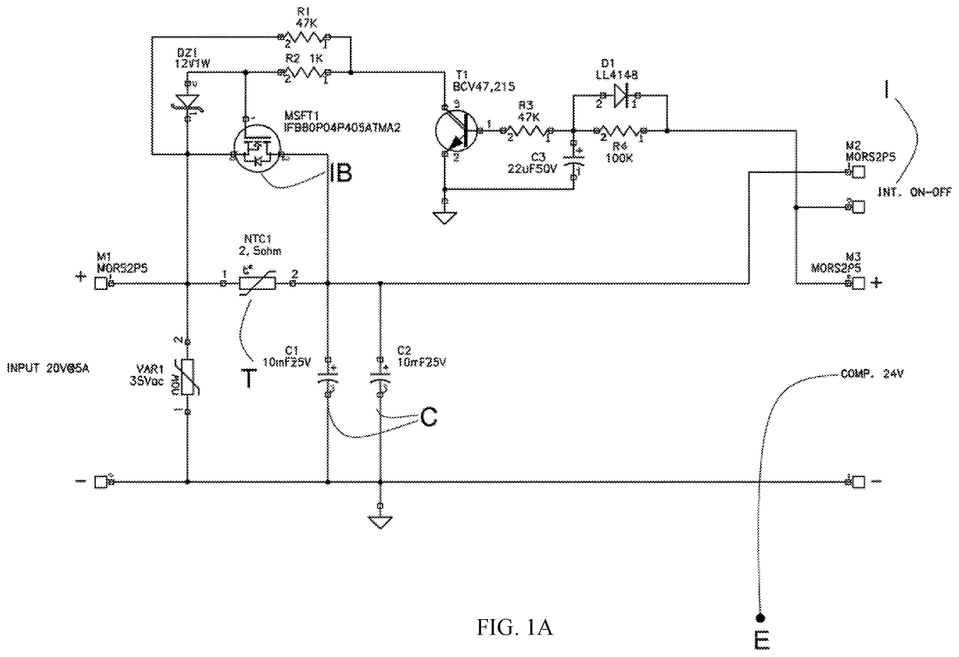

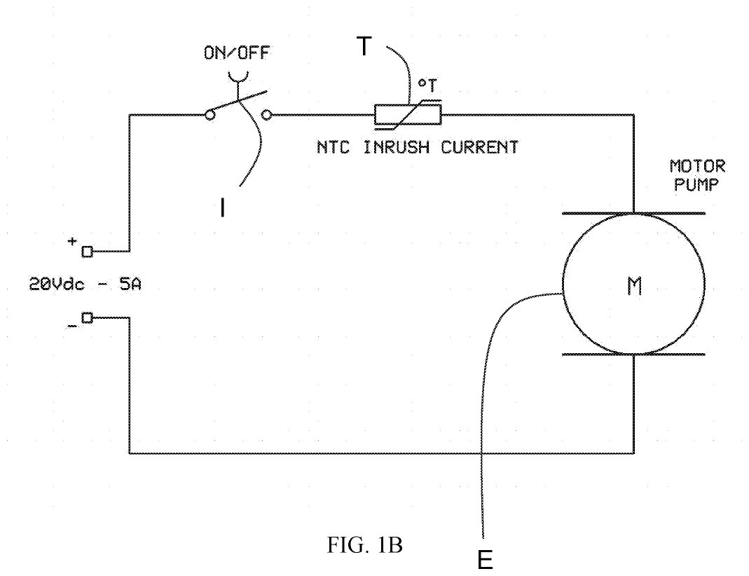

FIG. 1A or 1B illustrates a basic electrical diagram of a compressor according to the invention, including an electric motor E and an air pump having a maximum operating pressure up to 7 bar. The direct-current electric motor E, preferably brushed, and the pump are housed in an enclosure, preferably made of plastic. The pump can be reciprocating, rotary or of another type suitable for inflation and preferably also for injection of liquid sealant, and the compressor includes a detachable flexible hose for connecting the outlet of the pump to an air valve of a tire. Preferably, the compressor includes a pressure gauge for measuring, via the flexible hose, the pressure in the tire. Furthermore, according to the invention, the compressor includes an electric supply wire with a USB-C plug. The electric wire can be non-detachable, e.g. screwed or pressed against the enclosure, or the enclosure includes a USB outlet, preferably a USB-C outlet, and the electric wire includes a second USB plug, preferably also USB-C, to connect both mechanically and electrically in a releasable manner to the electric motor. This second option allows using an electric wire that can be purchased independently of the compressor, for example in case of damage or loss. It should be noted that the compressor of the invention is portable by hand, in particular with one hand, by any person driving a vehicle with tires and, through the electric wire, is powered by an onboard electrical energy source of the vehicle, for example a 20 V and 5 A nominal electrical energy source, i.e. a power delivery module of an auxiliary electrical circuit of a wheeled motor vehicle, preferably a direct-current electrical energy source. Said auxiliary electrical circuit powers the dashboard, interior courtesy lights, car radio, etc., and the power delivery module is powered by the auxiliary electrical circuit and includes an electrical safety circuit to control the delivery of electrical power not exceeding the nominal value and the electrical power outlet, e.g. USB, arranged e.g. on the dashboard for user electronic devices such as a mobile phone and the compressor of the invention. Said electrical circuit, in the case of hybrid or fully electric motor vehicles, is decoupled from the traction electrical circuit and the power delivery module of the auxiliary electrical circuit is located inside the passenger compartment, e.g. in the dashboard and/or in the trunk.

According to one aspect of the invention, between the electric wire and the electric motor E a voltage variation device is connected, configured to increase a supply voltage of the electric motor E from a low value to a high value corresponding to the maximum nominal power of the power outlet starting from when a user generates a pump switching-on command, for example via an electrical switch I. In this manner, the electric motor has a “soft start”, i.e. it starts even in the case of high loads by absorbing initially low and increasing voltage and current quantities. It should be noted that the switch I is both manual and automatic, e.g. electronically controlled, and activates the electric motor, the latter being for example capable of being switched off automatically, e.g. via a timer that switches off the motor when either a maximum inflation time, e.g. 20 minutes, has elapsed or when a predefined pressure is reached.

According to a preferred embodiment, the voltage variation device includes a variable resistor or thermistor, and even more preferably a negative temperature coefficient variable resistor, i.e. a resistor having a high value when cold which, due to the Joule effect of the current flowing through it during operation of the electric motor E, progressively decreases until ideally becoming null. With the electric motor E switched off, the resistor cools down and its resistance value increases again. The variable resistor in series with the electric motor E can be implemented in other ways, e.g. by means of a rheostat preferably controlled by an automatic control device configured to apply a predefined mathematical law of resistance variation over time, preferably a decrease of the resistance for at least a time interval so that, in the case of high load on the pump during such time interval, the electric current absorbed by the electric motor E, in particular a peak electric current, is kept below a predefined threshold value and such as not to damage the electrical power source of the auxiliary electrical circuit and/or not to cause activation of the safety circuits of the power delivery module that limit the delivered current. The latter indeed includes known safety circuits for controlling the delivered electric current, in particular also the peak current, below predefined thresholds so as not to damage the internal components of the power delivery module and/or of the auxiliary electrical circuit. Through the progressive voltage variation, the electric motor E progressively increases the rotational speed.

According to an alternative embodiment, the supply voltage variation device includes a microcontroller and a pulse-width-modulation (PWM) control to supply, through a variable duty cycle controlled by the microcontroller, a variable supply voltage of the electric motor, i.e. increasing from a low value up to reaching the maximum nominal supply voltage of the power delivery module. Preferably, the duty-cycle frequency is greater than 1 kHz, even more preferably 10 kHz, and 100% of the duty cycle corresponds to the maximum voltage, i.e. the nominal voltage of the power delivery module, e.g. 24 V. The duty-cycle variation over time can be set by programming of the control unit.

Also in the frequency-modulation embodiment, the start-up peak current is lower with respect to a configuration in which the supply voltage control is absent but in any case higher than the maximum nominal current deliverable by the power delivery module.

It should be noted that, while the voltage variation regulates the angular speed of the electric motor E, the power delivery supplies a constant voltage during the entire working cycle of the compressor, e.g. repair and inflation of the tire or inflation of the tire up to the operating pressure, for example 20 V, and a current dependent on the load of the pump during the working cycle.

With reference to FIG. 1A, one or more capacitors C onboard the compressor are provided, connected preferably but not exclusively upstream of the switch with respect to the electric motor E. The capacitors are electrical components having electrodes separated by a dielectric and operating as an open switch when charged and absorbing current, e.g. as closed switches during charging, and are therefore always connected in parallel to the motor with respect to the power supply outlet/plug. In particular, the capacitor(s) are rapidly charged, i.e. in less than 2 seconds of connection with the power outlet, to contribute to supplying the peak current at start-up under load of the pump. Since the capacitors supply current in the first instants of starting the electric motor, e.g. when the user closes the main switch I of the compressor, protection is provided to the circuits of the electrical power source and, at the same time, sufficient current is provided for start-up under load of the electric motor in the presence of the voltage variation device.

FIG. 1A further illustrates a controlled by-pass switch IB of the electrical resistance of the supply voltage variation device. The switch is closed to more promptly provide adequate values of current and/or voltage to the electric motor E in particular operating conditions, e.g. when a user starts the compressor again a second time shortly after having started it a first time. An example of such use will be described in greater detail below. Preferably, the controlled by-pass switch, e.g. a MOSFET, is normally open and is closed by means of a timer activated when the electric motor E is switched on. The timer for closing the controlled switch is set to define a time interval at the end of which the variable resistor can cool down while the electric motor E is still operating. This allows starting the compressor again even shortly after the first switching-on, taking advantage of the resistor under conditions suitable for soft-start, i.e. with a high resistance value and therefore low temperature. At the same time, the controlled switch performs a progressive closing law so that the voltage increases progressively and not stepwise. When the switch is a MOSFET, the closing time constant of the MOSFET is such as to reach the nominal voltage of the power delivery module within a time interval, e.g. less than or equal to 2 seconds. In most applications, the operating time of the variable resistor, counted from switching on the electric motor E, is a few seconds, e.g. 4 seconds, and the progressive increase of the voltage, e.g. during closing of the MOSFET when the variable resistor is bypassed, is lower. However, applications are possible in which the increase of the voltage up to the nominal value of the power delivery module after bypassing the variable resistor has a duration greater than the operating time of the variable resistor. In particular, given the gradual turn-off times of the MOSFET, i.e. comparable to the turn-off times of the NTC resistor, during the MOSFET's turn-off transient current continues to flow through the NTC resistor until the MOSFET is fully turned off.

FIG. 1B shows an embodiment in which the variable resistor, preferably the NTC resistor, is provided without capacitors, replaced, according to a preferred but non-limiting embodiment, by a buffer battery onboard the compressor (not shown) connected upstream of the switch with respect to the electric motor E. In the case of a charged battery, the current peak is supplied by the battery.

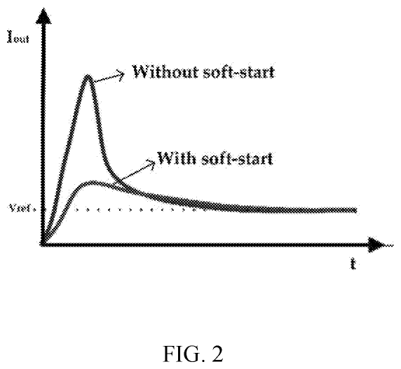

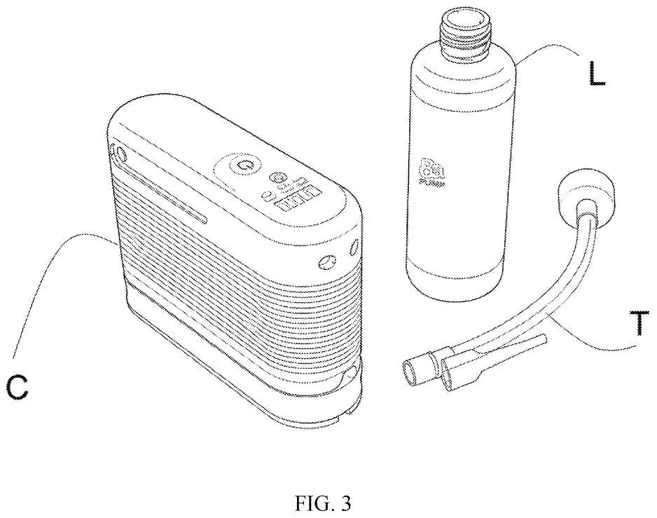

FIG. 3 shows a kit for repairing and inflating a tire including the compressor C, the compressible liquid sealant container L having a single port, i.e. an outlet port to which a tube Tis connected for manually injecting the liquid sealant into the tire. In the kit of FIG. 2, the compressor C inflates the tire but does not inject the liquid sealant and therefore does not contribute to repairing the tire. The container L is not pressurized, during injection of the liquid sealant, by the compressor C.

According to a first embodiment not illustrated, the invention is incorporated in a semi-automatic inflation and repair kit in which a liquid sealant container L1 includes an inlet for compressed air and an outlet for injecting the liquid sealant and a valve that closes the inlet and the outlet of the container L1 to preserve the liquid sealant when the kit is not in use and e.g. placed in a compartment of the vehicle. The compressor C is connected to the inlet of the container L1 so that an air flow rate generated when the compressor C is activated, i.e. while the electric wire is connected to the vehicle power outlet, opens the valve and, by pressurization of the container L1 by means of an air flow generated by the compressor C, liquid sealant is injected into the tire to be repaired.

According to said embodiment, the container L1 and the compressor C are stored fluidically disconnected from each other prior to use and, prior to repair, a user must manually connect the compressor C and the inlet of the container L1 to form a fluidic connection. In said embodiment, the compressor C, preferably the enclosure, includes a seat to which the container L1 is mechanically accoppiato in order to be kept in a liquid sealant injection position during pressurization of the container by the pump.

According to a further variant not illustrated, the container L1, also while being stored in a compartment of the vehicle, is mechanically connected to such seat in a releasable manner to have a fixed position with respect to the compressor both when it is stored in a vehicle compartment and while it injects liquid sealant or while a tire is inflated. Preferably, the overall size of the container L1 mechanically connected to the compressor is parallelepipedal and in such configuration the container is both external to the compressor C and entirely housed in a specific compartment of the compressor enclosure.

According to a variant not illustrated, the variation of the supply voltage, i.e. the increase of the supply voltage from a low value up to the nominal voltage of the power delivery module, is carried out by means of a device that connects in parallel with respect to the motor E a constant-value resistor and a MOSFET having a closing time of a few seconds. In this manner, there is a transient of at least 4 seconds in which the supply voltage of the motor E increases until reaching the nominal value of the power delivery module. Preferably, when the electric motor E is started, the MOSFET is open and the supply voltage of the electric motor is constant and based on the fixed electrical resistance. After a predefined time interval, for example controlled by a timer, the MOSFET progressively closes, e.g. in 1 second or more, preferably in two seconds or more, and progressively the supply voltage of the electric motor E increases.

Furthermore, the timer is implemented by any device capable of ensuring execution within a predetermined time, e.g. a counter or, in the case of the MOSFET, a capacitor having a suitable capacitance to achieve closing within the desired time interval.

It should be noted that the present invention is applicable to any compressor driven through a powered data-exchange port, in which the data include a supply voltage value of the compressor, said value being provided to the power delivery by a controller arranged onboard the compressor or onboard the power and data-exchange wire, preferably in a wired plug.

According to a further embodiment, the compressor includes a controller configured to detect the current absorbed during use by the electric motor E and to modify the operating parameter(s) of the PWM, e.g. the duty cycle, based on the measured current. Such variation is carried out while keeping unchanged, i.e. constant, the voltage supplied by the power delivery during the entire working cycle of the compressor, e.g. repair of the tire or inflation of the tire up to nominal pressure. Similarly, in the embodiment providing the MOSFET, the controller controls the MOSFET based on the absorbed current.

In an embodiment not illustrated, the device for regulating the supply voltage of the electric motor E, both in the passive embodiment, i.e. open loop, and in the active one, i.e. with measurement of the current absorbed by the electric motor, can also be implemented in a module carried by the electric wire.

If it is necessary to increase the performance of the electrical noise filter of the motor E, a diode, preferably a flyback diode, can be provided, combined with a variator.

What is claimed is:

1. A compressor for inflating a tire, comprising:
a direct-current electric motor,
a pump driven by the direct-current electric motor,
an outlet or a plug, preferably USB, for electrical power supply of the direct-current electric motor, and
a voltage variation device for varying a supply voltage of the direct-current electric motor and configured to increase the supply voltage from a low value to a high value starting from when the direct-current electric motor is switched on to generate compressed air so as to increase the supply voltage during operation of the direct-current electric motor.

2. The compressor according to claim 1, wherein the voltage variation device comprises a variable resistor arranged in series between the direct-current electric motor and the plug or outlet, wherein a reduction of a resistance of the variable resistor is variable so as to avoid absorbed current peaks while keeping an absorbed current below a predefined threshold.

3. The compressor according to claim 2, wherein a variable electrical resistance is configured to vary based on temperature due to the Joule effect.

4. The compressor according to claim 2, further comprising a controlled by-pass switch, preferably a MOSFET, arranged in parallel with the variable resistor and controlled to close and bypass the variable resistor, preferably with a closing time to reach a nominal supply voltage of a power delivery module greater than or equal to 1 second.

5. The compressor according to claim 4, wherein the controlled by-pass switch is controlled to close based on a timer activated upon a switch-on of the direct-current electric motor.

6. The compressor according to claim 1, wherein the voltage variation device comprises a PWM module to modulate a voltage of a power delivery module.

7. The compressor according to claim 1, further comprising a first USB outlet and an electric wire with a first USB plug for connecting to the USB outlet and a second USB plug suitable for connecting to a second USB outlet of a vehicle.

8. The compressor according to claim 1, further comprising at least one capacitor connected in parallel with the direct-current electric motor and in parallel with the outlet or plug so as to supply a starting current defined through the voltage variation device when the direct-current electric motor is switched on to generate compressed air and increase a number of revolutions, and so that, after becoming electrically discharged, the direct-current electric motor continues to be powered through the outlet or plug, and wherein the outlet or plug is for electrical power supply of the direct-current electric motor through a power delivery module of an auxiliary electrical circuit of a wheeled terrestrial motor vehicle.

9. The compressor according to claim 1, wherein a capacitor is arranged between a switch and the outlet or plug so as to be charged when the outlet or plug is electrically connected to a power delivery module and the switch is in a position of the direct-current electric motor switched off.

10. The compressor according to claim 8, wherein the capacitor has an overall capacitance less than or equal to 0.05 Farad, preferably less than or equal to 0.022 Farad, with a charging voltage of 20 Volts.

11. The compressor according to claim 1, wherein a microcontroller is configured to communicate, through a USB outlet or plug, a nominal voltage to a vehicle power supply, such voltage being modified in use through the voltage variation device to progressively increase a number of revolutions of the direct-current electric motor.

12. The compressor according to claim 1, comprising a mechanical coupling seat with a liquid sealant container configured so as to keep the liquid sealant container in a liquid sealant injection position when the liquid sealant container is pressurized through a fluidic connection with the pump.

13. The compressor according to claim 1, comprising a controller configured to control a voltage regulation device based on the current absorbed by the direct-current electric motor during generation of compressed air.

14. The compressor according to claim 1, wherein the voltage regulation device is configured to execute a predefined law of increase over time of the supply voltage of the direct-current electric motor.

15. A kit for repairing and inflating a tire comprising the compressor according to claim 1 and a liquid sealant container to be injected into the tire.

16. The kit according to claim 15, wherein the liquid sealant container comprises an inlet connectable to the compressor to pressurize the liquid sealant container and an outlet configured to inject a pressurized liquid sealant through the compressor.

17. A method for inflating a tire comprising:
connecting the compressor according to claim 1 to a USB outlet of a vehicle through a USB plug;
fluidically connecting a delivery of the compressor to the tire of the vehicle; and
switching on the compressor.

18. The compressor according to claim 3, further comprising a controlled by-pass switch, preferably a MOSFET, arranged in parallel with the variable resistor and controlled to close and bypass the variable resistor, preferably with a closing time to reach a nominal supply voltage of a power delivery module greater than or equal to 1 second.

19. The compressor according to claim 2, further comprising a first USB outlet and an electric wire with a first USB plug for connecting to the USB outlet and a second USB plug suitable for connecting to a second USB outlet of a vehicle.

20. The compressor according to claim 3, further comprising a first USB outlet and an electric wire with a first USB plug for connecting to the USB outlet and a second USB plug suitable for connecting to a second USB outlet of a vehicle.
